(19) United States
(12) Patent Application Publication
(10) Pub. No.: US 2012/0210829 A1
(43) Pub. Date: Aug. 23, 2012

(54) RATCHET WRENCH CAPABLE OF PREVENTING DISENGAGEMENT OF NUT

(76) Inventor: Chih-Min CHANG, Changhua County (TW)

(21) Appl. No.: 13/076,851

(22) Filed: Mar. 31, 2011

(30) Foreign Application Priority Data
Feb. 22, 2011 (TW) 100203166

(51) Int. Cl. B25B 13/46

(52) U.S. Cl. 81/63.2

(57) ABSTRACT

A ratchet wrench includes a wrench body having a through hole, a driving member rotatably mounted in the through hole and having a center hole for engagement with a nut, a pawl, a positioning device, a magnetic ring mounted on a top side of the driving member, and a block ring capped on the driving member and having a stop flange in contact with a top side of the magnetic ring. The magnetic ring is used to retain the nut in the center hole such that the nut is unable to drop out of the center hole of the driving member when the nut is tightened or loosened by the ratchet wrench.

### BACKGROUND OF THE INVENTION

1. Field of the Invention

The present invention relates to a ratchet wrench and more particularly, to a ratchet wrench that can prevent accidental disengagement of a nut held therein during operation.

2. Description of the Related Art

A conventional ratchet wrench includes a coupling hole at a distal end thereof and a driving member rotatably mounted in the coupling hole for engagement with a nut such that the nut can be tightened or loosened through the rotation of the driving member.

According to the aforesaid design, the coupling hole is a through hole formed through the top and bottom sides of the distal end of the ratchet wrench such that the nut may easily drop out of the through hole, causing the nut to be difficultly screwed onto a bolt. Under this circumstance, a worker may have to put the nut into the through hole and adjust the position between the nut and the bolt again and again until the nut is threaded with the bolt. Further, the ratchet wrench is likely to slip from the worker's hand during tightening or loosening the nut due to the separation of the nut from the through hole, possibly causing damage to the worker.

Therefore, the applicant of the present invention has provided a ratchet wrench, which is disclosed in Taiwan Patent No. M363967 corresponding to U.S. patent application Ser. No. 12/385,105, that is able to retain the nut in the through hole to prevent disengagement of the nut from the through hole during operation.

### SUMMARY OF THE INVENTION

It is the primary objective of the present invention to provide a ratchet wrench, which can prevent disengagement of a nut from a coupling portion thereof and enhance the convenience of operation.

To achieve this objective of the present invention, the ratchet wrench comprises a wrench body, a driving member, a pawl, a positioning device, a magnetic ring, and a block ring. The wrench body has a head, a through hole through the top and bottom sides of the head, and a chamber recessed inwards at a periphery of the through hole. The driving member is rotatably mounted in the through hole of the wrench body, and has a center hole and an annular teeth portion around an outer periphery thereof. The pawl is mounted in the chamber of the wrench body and has a toothed front wall engaged with the annular teeth portion of the driving member. The positioning device is mounted in the chamber of the wrench body and abutted against the pawl for supporting the pawl against the driving member. The magnetic ring is coaxially mounted on a top side of the driving member. The block ring is coaxially capped on the driving member and has a stop flange extending inwards along a radial direction thereof.

Accordingly, when the ratchet wrench of the present invention is engaged with a nut through the center hole of the driving member, the nut can be retained in the center hole of the driving member by the magnetic attraction between the nut and the driving member and/or between the nut and the magnetic ring such that the nut is unable to drop out of the center hole of the driving member when the nut is tightened or loosened by the ratchet wrench, thereby enhancing the convenience of tightening and loosening the nut, and reducing the risk of occupational injuries.

In a preferred embodiment of the ratchet wrench of the present invention, the internal diameter of the magnetic ring is smaller than that of the center hole of the driving member, such that the nut can be retained in the center hole of the driving member by the magnetic ring without disengagement from the center hole.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a ratchet wrench according to a preferred embodiment of the present invention;

FIG. 2 is a cross-sectional view of the ratchet wrench according to the preferred embodiment of the present invention; and

FIG. 3 is a schematic view of the preferred embodiment, showing that a nut is engaged with the center hole of the driving member.

### DETAILED DESCRIPTION OF THE INVENTION

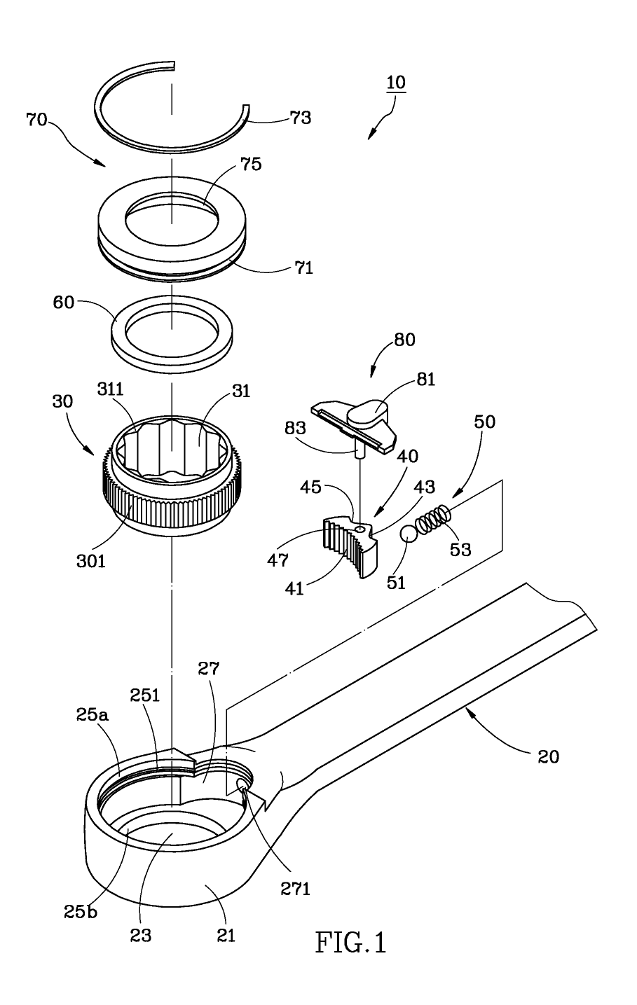

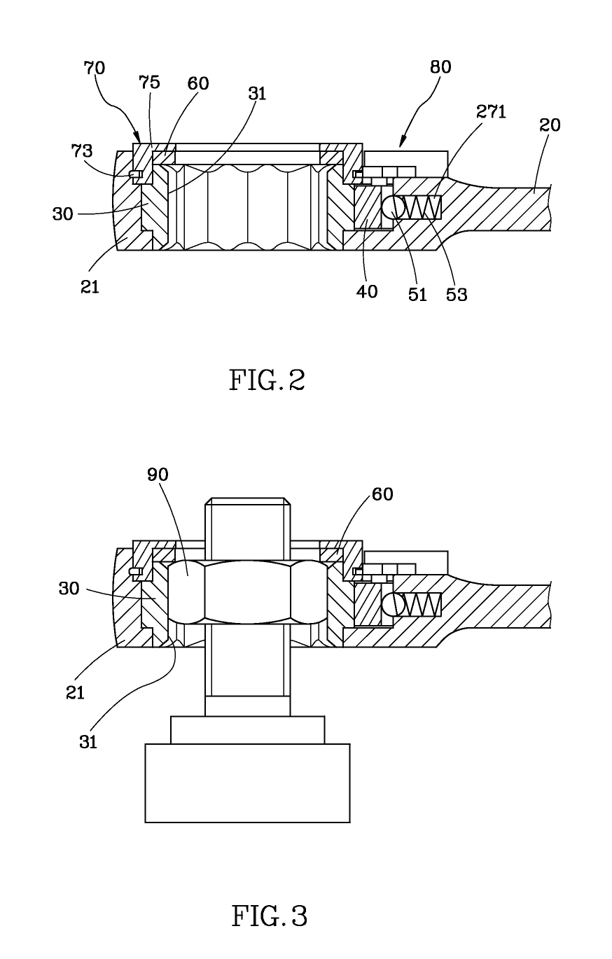

Referring to FIG. 1 to FIG. 2, a ratchet wrench 10 provided by a preferred embodiment of the present invention mainly comprises a wrench body 20, a driving member 30, a pawl 40, a positioning device 50, a magnetic ring 60, and a block ring 70.

The wrench body 20 has a head 21, a through hole 23 through the top and bottom sides of the head 21, two flanges 25a, 25b projecting inwards from peripheries of the top and bottom ends of the through hole 23, a chamber 27 recessed inwards at the periphery of the through hole 23, and a blind hole 271 recessed inwards at a periphery of the chamber 27. The flange 25a has an insertion groove 251.

The driving member 30 has a center hole 31 for engagement with a nut, an inner annular teeth portion 311 around a periphery of the center hole 31, and an outer annular teeth portion 301 around an outer periphery thereof. The driving member 30 is rotatably mounted in the through hole 23 of the wrench body 20 in such a way that the center hole 31 is coaxial with the through hole 23.

The pawl 40 is provided with a toothed front wall 41 facing the driving member 30, a first concavity 43 at the rear side thereof, a second concavity 45 at the rear side thereof, and a coupling hole 47 through the top and bottom sides thereof. The pawl 40 is mounted in the chamber 27 of the wrench body 20, and the toothed front wall 41 can be forced into engagement with the outer annular teeth portion 301 of the driving member 30. In actual use, a rod may be used to insert into the coupling hole 47 of the pawl 40 such that the rod can be forced to move the pawl 40 in the chamber 27, resulting in that the driving member 30 can be controlled to rotate clockwise or anticlockwise.

Specifically speaking, the ratchet wrench 10 further includes a slider 80 as shown in FIG. 1 for enabling workers to conveniently control the rotation direction of the driving member 30. The slider 80 includes a tab 81 and a coupling rod 83 extending from the bottom side of the tab 81 and inserted into the coupling hole 47 of the pawl 40 such that workers can force the slider 80 to move the pawl 40 in the chamber 27 so as to determine the rotation direction of the driving member 30.

The positioning device 50 is composed of a ball 51 and a spring member 53 in the present embodiment. As shown in FIG. 2, the positioning device 50 is mounted in the blind hole 271 of the wrench body 20. The spring member 53 has two ends stopped against the ball 51 and a bottom wall of the blind hole 271 for providing a spring force to push the ball 51 into engagement with either of the first concavity 43 and the second concavity 45 of the pawl 40, enabling the toothed front wall 41 of the pawl 40 to be engaged with the outer annular teeth portion 301 of the driving member 30.

The magnetic ring 60 is an annulus with magnetism and has an internal diameter smaller than that of the center hole 31. Preferably, the magnetic ring 60 is rare earth magnet such as NdFeB (neodymium iron boron) magnet. The magnetic ring 60 is coaxially mounted on a top side of the driving member 30 so as to magnetize the driving member 30.

The block ring 70 is provided with an insertion groove 71 around an outer periphery thereof for insertion of a retainer 73, and a stop flange 75 extending inwards along a radial direction thereof The block ring 70 is coaxially capped on the driving member 30 in such a way that the retainer 73 inserted in the insertion groove 71 of the block ring 70 is engaged with the insertion groove 251 of the wrench body 20 to secure the block ring 70 to the wrench body 20, and the stop flange 75 is abutted against a top side of the magnetic ring 60 to secure the magnetic ring 60 to the wrench body 20.

As shown in FIG. 3, when the ratchet wrench 10 of the present invention is engaged with a nut 90 through the center hole 31 of the driving member 30, since the the inner periphery of the center hole 31 of the driving member 30 is magnetized by the magnetic ring 60, the nut 90 can be retained in the center hole 31 of the driving member 30 by the magnetic attraction between the nut 90 and the driving member 30 and/or between the nut 90 and the magnetic ring 60. Besides, because the magnetic ring 60 has the internal diameter smaller than that of the center hole 31, the nut 90 can't pass through the opening of the magnetic ring 60 so as to be retained in the center hole 31 of the driving member 30. As a result, when a worker uses the ratchet wrench 10 of the present invention to tighten or loosen the nut 90, the nut 90 is unable to drop out of the center hole 31 of the driving member 30, thereby enhancing the convenience of the securing work of the nut and reducing the risk of occupational injuries.

In conclusion, because of the installation of the magnetic ring, the nut can be retained in the center hole of the driving member by the magnetic attraction between the nut and the driving member and/or between the nut and the magnetic ring such that the nut is not easy to drop out of the wrench body. In addition, because the magnetic ring has the internal diameter smaller than that of the center hole, it can be effectively prevented that the nut passes through the opening of the magnetic ring, thereby enhancing the convenience of tightening and loosening the nut.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ratchet wrench comprising:
a wrench body having a head, a through hole through top and bottom sides of the head, and a chamber recessed inwards at a periphery of the through hole;
a driving member rotatably mounted in the through hole of the wrench body, and having a center hole and an annular teeth portion around an outer periphery thereof;
a pawl mounted in the chamber of the wrench body and having a toothed front wall engaged with the annular teeth portion of the driving member;
a positioning device mounted in the chamber of the wrench body and abutted against the pawl for supporting the toothed front wall of the pawl against the annular teeth portion of the driving member;
a magnetic ring coaxially mounted on a top side of the driving member; and
a block ring coaxially capped on the driving member and having a stop flange extending inwards along a radial direction thereof and being in contact with a top side of the magnetic ring.

2. The ratchet wrench as claimed in claim 1, wherein the magnetic ring has an internal diameter smaller than that of the center hole of the driving member.

3. The ratchet wrench as claimed in claim 1, further comprising a slider connected to the pawl to move the pawl in the chamber of the wrench body.

4. The ratchet wrench as claimed in claim 3, wherein the pawl has a coupling hole, and the slider has a coupling rod inserted into the coupling hole of the pawl.

5. The ratchet wrench as claimed in claim 1, wherein the wrench body has a blind hole recessed inwards at a periphery of the chamber, and the positioning device includes a ball rested inside the blind hole and stopped against the pawl, and a spring member rested inside the blind hole and having two ends stopped against the ball and a bottom wall of the blind hole.
